(19) United States
(12) Patent Application Publication
(10) Pub. No.: US 2011/0174091 A1
(43) Pub. Date: Jul. 21, 2011

(54) PENETRATION DEVICE FOR DRIVING A TOOL, SUCH AS A SOIL PROBING OR SAMPLING TOOL, AND ASSEMBLIES OF SUCH A DEVICE, AND SUCH A TOOL

(75) Inventor: Johannes Harmannus Brinker, Gorredijk (NL)

(73) Assignee: A.P. VAN DEN BERG HOLDING B.V., Heerenveen (NL)

(21) Appl. No.: 13/009,008

(22) Filed: Jan. 19, 2011

(30) Foreign Application Priority Data
Jan. 19, 2010 (NL) 2004112

(51) Int. Cl. G01N 1/04

(52) U.S. Cl. 73/864.74; 73/864.74

(57) ABSTRACT

A penetration device (1) for driving a tool (2), such as a soil probing or sampling tool, includes a cylindrical tube (3), a first piston (4) and a second piston (5), both fixedly arranged with a piston rod (6) and slidably displaceable through the cylindrical tube (3), and partitioning means (7) for forming a partition between a first chamber (8) and a second chamber (9). The first piston (4) and the second piston (5) and the tube (3) and the partitioning means (7) together define the first chamber (8) and the second chamber (9).

### CROSS-REFERENCE TO RELATED APPLICATIONS

This application claims the benefit of Netherlands Application No. 2004112, filed Jan. 19, 2010, the contents of which is incorporated by reference herein.

### SUMMARY OF THE INVENTION

The invention relates to a penetration device for driving a tool, such as a soil probing or sampling tool. Furthermore the invention relates to assemblies of such a device and such a tool.

### BACKGROUND OF THE INVENTION

Penetration devices are widely used in systems for investigating the geophysical and geotechnical properties of soil. Such a penetration device is lowered in a pipeline present in an existing bore hole. After the penetration device has reached the bottom of the bore hole a tool is driven into the soil. When investigating soil at the sea floor the penetration device has to cope with high pressures due to the depth.

A known penetration device that can be used in such conditions comprises a piston which is slidably displaceable through a cylindrical tube dividing the cylindrical tube liquid tightly into a first and a second chamber. A first piston-rod-guide-assembly and a second piston-rod-guide-assembly, both fixedly arranged with a piston rod and with the cylindrical tube, define the end portions of the first and the second chamber. Hydraulic fluid is fed into the first chamber, such that the pressure is increased and the piston will be slidably displaced through the cylindrical tube to drive the tool into the soil. There are several drawbacks relating to this known device.

The piston rod of this known penetration system has two functions. It is part of the driving mechanism, as a regular piston rod, but also functions as part of the tool in that is at least partly penetrated into the soil. Because the part of the piston rod that contacts the soil often becomes slightly damaged and contaminated, retracting this part generally damages or wears away the piston-rod-guide-assembly. Sea water will pass through and further harms the chamber the piston part retracts in. In addition, this chamber can be contaminated by soil sticking to the piston part.

Another drawback is that the hydraulic fluid needs to be transported from above sea level to near the sea bottom. The system pressure required to achieve the appropriate pressure at the sea bottom increases with the length of the conduit and meets its limits at a conduit length of around 600 metres.

Furthermore, the hydraulic fluid volume increases with the length of the conduit which will decrease the direct control of the penetration and could result in irregular penetration rates in situations the tool experiences different friction effects.

In addition, in a long conduit slight variations of conduit width will result in large variations of hydraulic fluid volume. Because depth measurement usually is related to the hydraulic fluid volume used for penetration, variation of this volume will results in inaccurate measurements. Therefore also control of penetration of the tool into the soil is inaccurate.

The length of one stroke of the piston rod is defined by the distance between the first and second piston-rod-guide-assembly. In the known device this distance determines, and is always about equal to, the penetrating distance of the tool. Tools having different functions, such as probing or sampling, often need different penetrations distances. Therefore changing a tool requires changing the penetration device. For tools requiring different penetration distances different penetration devices are required.

Yet another drawback is the inability for this known penetration device to retract the tool to its upward position. This is due to the fact that because of the high pressures involved only one-way feeding of hydraulic fluid is possible. The tool has to be retracted as part of the penetration device by a pulling force originating from above sea level. Changing a tool includes pulling the penetration device to above sea level, pushing the piston back to its upward position, usually using water pressure, and recovering the hydraulic fluid in a container for further use.

Another drawback is storing the hydraulic fluid. Each time the penetration device with a specific tool has been used, the hydraulic fluid in the chamber of the device has to be stored above sea level in a specific voluminous container. Emptying the device is time consuming.

The object of the present invention is to at least partly overcome the drawbacks related to known penetration devices as described above, and/or to provide a usable alternative. A further goal is to provide assemblies of such a penetration device and such a tool.

### SUMMARY OF THE INVENTION

The invention therefore provides a penetration device for driving a tool, such as a soil probing or sampling tool, comprising, a cylindrical tube, a first piston and a second piston, both fixedly arranged with a piston rod and slidably displaceable through the cylindrical tube, and partitioning means for forming a partitioning between a first chamber and a second chamber, whereby the first piston, the second piston, the tube and the partitioning means together define the first chamber and the second chamber.

The advantage of this penetration device is that while driving the tool into the soil a piston rather than a piston-rod-guide-assembly defines the end portion of the lower chamber. This means that in a working situation a piston rather than a piston-rod-guide-assembly is facing the soil and water surroundings. Because the pistons are fixedly arranged with the piston rod and are simultaneously displaced through the cylindrical tube, the device does not suffer from a damaged piston rod or tool. The sealing between the piston and the cylindrical tube prevents contamination and water come into the chambers and maintains the chambers intact.

The device according to this invention comprises pumping means for pumping hydraulic fluid from the one chamber to the other chamber or vice versa. This pumping results in an increased pressure in one of the chambers and consequently in the displacement of the pistons relative to the partitioning means, for example for driving the tool into the soil.

One advantage of this penetration device is that the hydraulic fluid will remain in the penetration device, mainly in one or both of the chambers. No voluminous container for storage of hydraulic fluid is needed. Advantageously the pumping means can now be located inside the penetration device, preferably in the vicinity of the chambers, for example adjacent to the piston that during penetration is the upper piston. Thus only a short distance has to be bridged. As a result there is no substantial loss of pumping energy, for example due to widening of the conduit during transport of the hydraulic fluid. Therefore, the penetration device can be used under conditions of greater depth, for example more than 3.000 metres, than penetration devices known from the art, approximately 600 m.

Preferably, the hydraulic system of the penetration device can be adjusted to high pressures at great depths. System for adjusting a hydraulic system to high pressures are known to the skilled person. In addition, in case of measurements related to the volume of hydraulic fluid, these measurements can be more accurate because of the reduced hydraulic fluid volume and the absence of widening of a conduit.

Preferably the pumping means should have such dimensions that the penetration device is still able to be lowered into a pipeline located in a bore hole. Preferably, the cylindrical tube is extending in a direction opposite to the direction of penetration such that it at least partly surrounds the pumping means.

In an embodiment the pumping means are slidably displaceable through the cylindrical tube together with the assembly of the first and second pistons and the piston rod. For this the pumping means are connected to this assembly directly or indirectly, for example connected to the piston that during penetration is the upper piston. Thus the pumping means are always located at a same constant distance from the chambers between which they need to transport hydraulic fluid during operation.

In a further embodiment a conduit is provided which extends from the first chamber to the pumping means and from there to the second chamber. Advantageously a first part of this conduit extends from the first chamber through the piston rod and through the second piston towards the pumping means, and a second part of the conduit extends from the pumping means through the second piston towards the second chamber.

With “penetration device” is meant a device of which at least the main part can be moved in a duct, for example lowered in a pipeline present in a bore hole.

With “cylindrical tube” is meant a tube through which the pistons can be slidably displaced and that is partly defining part of the chambers. The cylindrical tube preferably is a tube section that coupled with other similar tube sections can form a string that fits into an existing bore hole from which the penetration of the tool has to take place. Such cylindrical tubes are common in sampling or probing and have standard proportions.

Preferably, the partitioning means is forming a liquid tight partition to be able to efficiently use hydraulic fluid to slidably displace the pistons.

One tool can be a cone for performing a Cone Penetration Test (CPT). Another tool can be a hollow tube to take samples from the soil.

Preferably, the partitioning means are fixedly arranged with the cylindrical tube to drive the tool into the soil by slidably displacing the pistons. This fixed arrangement prevents the partitioning means in a working situation moving upwardly. Although the gravity effect resulting from the weight of the penetration device will in situations of loosely packed soil force the tool into the soil, in situations of tightly packed soil this will not be sufficient. Preferably, the partitioning means are integrated in the tube.

Preferably, the partitioning means also form guiding means for guiding the piston rod. Preferably, the guiding means are liquid tight to be able to efficiently use hydraulic fluid to slidably displace the pistons. In this way the first chamber and the second chamber can be defined by the first piston, the second piston, the tube, the partitioning means together with the piston rod. Preferably, the piston rod is arranged coaxially with the cylindrical tube.

Because the length of the stroke of the piston rod can be regulated accurately, different tools requiring different strokes can be fixedly arranged without having to change other components of the penetration device. Therefore the penetration device preferably, comprises fixing means for fixedly arranging the tool. Preferably, the penetration device comprises a rod, extending from the piston being in a working situation closest to the soil, which rod is provided with the fixing means. These fixing means could comprise normal screw thread.

Preferably, the penetration device according to the invention comprises reversing means for reversing the pumping direction of the pumping means. Such a penetration device is capable of driving as well as retracting the tool. As a consequence this penetration device, unlike known penetration devices, has the ability to retract the tool in its upward position. In this upward position the tool could be surrounded by the cylindrical tube to protect the tool during lowering and lifting of the penetration device. This is especially advantageous in case of a sampling tool. Lifting known penetration devices provided with a sampling tool, in which a sample is included, often disturbs the sample. Retracting the tool without having to retract the penetration device itself is advantageous because it can be performed more accurately such that the tool or the rod will not be damaged. The reversing means preferably comprise a valve shaft.

Another preferred embodiment of a penetration device according to this invention comprises a housing for housing the pumping means, and possibly also the abovementioned reversing means. Preferably, this housing extends in a direction opposite to the direction of penetration, preferably approximately from the piston that in a working situation is the upper piston. The housing should have such dimensions that the penetration device is still able to be lowered into a pipeline located in a bore hole. Preferably, the cylindrical tube is extending in the same direction as the housing to at least partly surround the housing.

Preferably, the penetration device contains driving means for driving the pumping means.

Preferably, the penetration device comprises energy storing means coupled to the pumping means.

Preferably, the energy storing means comprise a battery pack.

Yet another preferred embodiment of a penetration device according to this invention comprises regulatory means for controlling the driving means. The regulatory means can comprise a data acquisition system functionally coupled to the driving means. The regulatory means could comprise a printed circuit board coupled to one or more sensors (see hereunder). Preferable, the regulatory means can control the pumping direction of the hydraulic fluid, so penetration or retraction of the tool. Preferably, the device comprises one or more sensors of a group containing an oil pressure sensor, an oil temperature sensor, and a sensor for sensing the conduction of the oil, the sensor being coupled to the regulatory means. Using data from these sensors the device can react on the actual conditions near the penetration device. When working at great depths these conditions are very different from those above sea level and difficult to predict.

Preferably, the penetration device comprises distance measuring means for measuring the distance between a piston and the partitioning means. One advantage of the present invention is that the piston rod is not required to have the same dimensions as the tool. Therefore the piston rod can be wider and comprise a hollow space to enable the distance measuring means to measure said distance. Preferably, the distance measuring means are able to communicate with the regulatory means.

Advantageously the reversing means and/or the driving means and/or the energy storing means and/or the regulatory means and/or the sensor(s) and/or the distance measuring means can now also be located inside the penetration device, for example inside a common housing, preferably the same one as where the pumping means are also located inside, and preferably also in the vicinity of the chambers, for example adjacent to the piston that during penetration is the upper piston, and preferably slidably displaceable through the cylindrical tube together with the assembly of the first and second pistons and the piston rod.

In addition, the invention provides an assembly of a penetration device, as described above, and a tool, the tool being a cone.

The invention further provides an assembly of a penetration device, as described above, and a tool, the tool being a hollow tube for taking samples.

The invention further provides an assembly of a penetration device, as described above, and a tool, the tool being a vane tester for determining the shear strength. The shear strength can be determined in remolded soil or in undrained soil.

The invention further provides an assembly of a penetration device, as described above, and a tool, the tool being a seismic sensor. This tool can determine the effect near the sensor of a remote strike. It could comprise an acceleration sensor.

### BRIEF DESCRIPTION OF THE DRAWINGS

The invention will be further elucidated with reference to a non-limitative preferred embodiment of the device according to the present invention.

FIGS. 1 (A and B) shows schematic illustrations of a typical prior art penetration device.

FIGS. 2 (A and B) shows schematic illustrations of the non-limitative preferred embodiment of the penetration device according to the present invention.

FIG. 3 shows a perspective view of a part of the non-limitative preferred embodiment of the penetration device according to the present invention, without cylindrical tube.

FIG. 4 shows a schematic cross section of the non-limitative preferred embodiment of the penetration device according to the present invention.

### DETAILED DESCRIPTION OF THE INVENTION

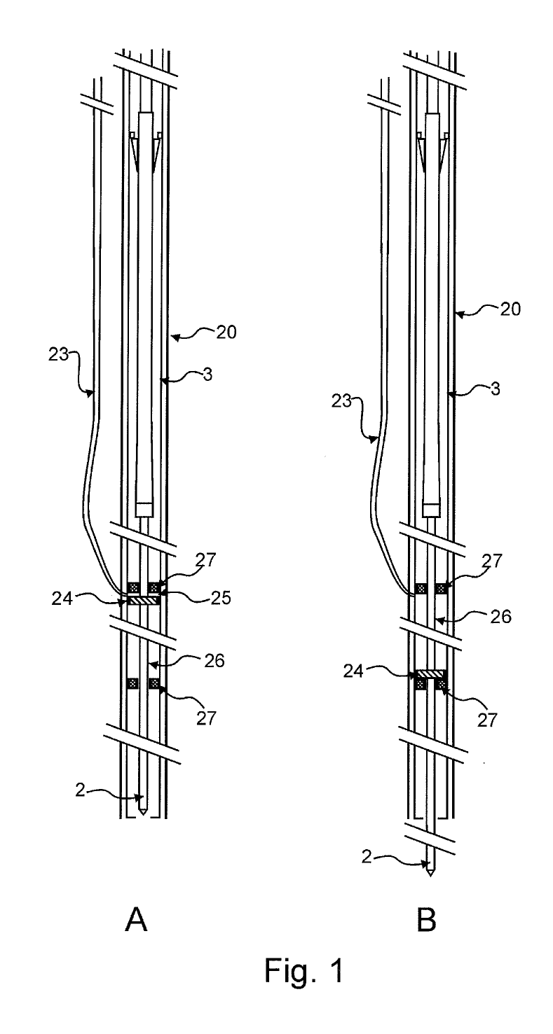

FIGS. 1A and 1B show schematic illustrations of a typical prior art penetration device in which the tool (2) is located in the upward position protected by the cylindrical tube (3) (FIG. 1A) and down in the soil (FIG. 1B) respectively. This device comprises two partitioning means (27) and only one piston (24). Through the conduit (23) the hydraulic fluid can be transported from above sea level to the chamber (25) that can be filled with hydraulic fluid to drive the tool (2) into the soil. The cross section of the piston rod (26) is identical to that of the tool (2).

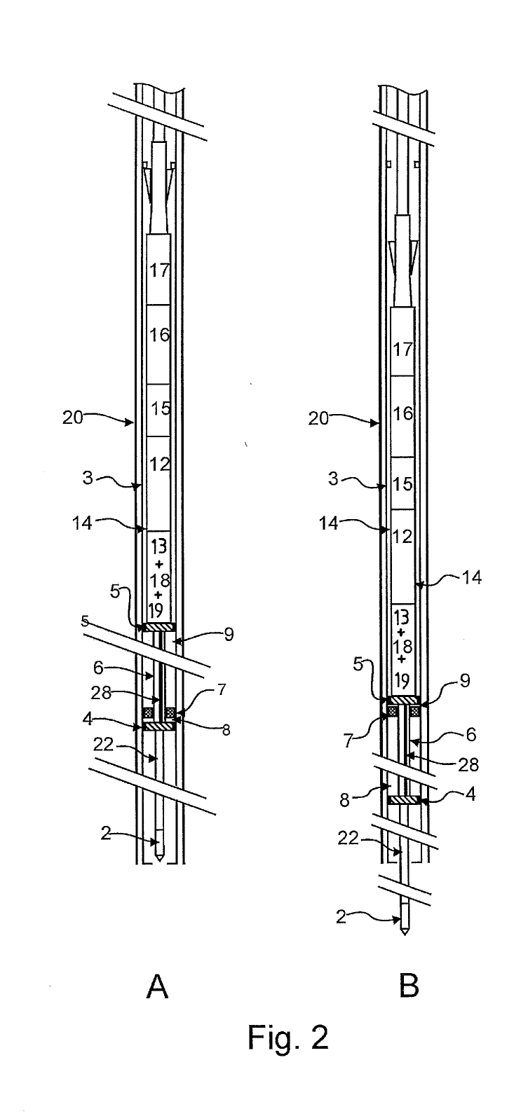

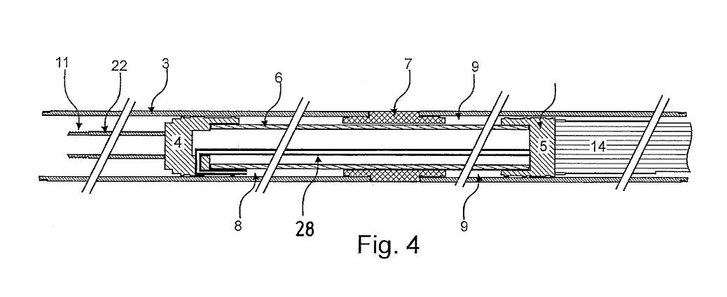

In FIG. 2A is shown that the embodiment of the penetration device (1) according to the invention for driving a tool (2), such as a soil probing or sampling tool, comprises a cylindrical tube (3), a first piston (4) and a second piston (5), both fixedly arranged with a piston rod (6) and slidably displaceable through the cylindrical tube (3), and partitioning means (7) for forming a partition between a first chamber (8) and a second chamber (9), whereby the first piston (4) and the second piston (5) and the tube (3) and the partitioning means (7) together define the first chamber (8) and the second chamber (9). Due to pumping means (12) functionally coupled to a conduit (28, and others not shown) the first chamber (8) can be filled with hydraulic fluid to drive the tool (2) into the soil (See FIG. 2B). The partitioning means (7) also form guiding means (10) for guiding the piston rod (6). Shown is a conduit (28), that runs through the piston rod (6), of which one end terminates in the first piston (4) on the side that is facing the first chamber (8) (See also FIG. 4). The device further comprises a housing (14) comprising the pumping means (12) as well as reversing means (13) for reversing the pumping direction of the pumping means (12) (not shown), driving means (15) for driving the pumping means (12), energy storing means (16) coupled to the driving means (15) for supplying energy to the driving means, which energy storing means (16) comprise a battery pack (17). Finally, the housing (14) comprises regulatory means (18) for controlling the driving means (15) which regulatory means (18) are functionally coupled to an oil pressure sensor (not shown), an oil temperature sensor (not shown), and a sensor for sensing the conduction of the oil (not shown). The device comprises a rod (22), extending from the first piston (4) being in a working situation closest to the soil, which rod (22) is provided with the fixing means (11) (see also FIG. 4). Also shown in FIG. 1 and FIG. 2 is a pipeline (20) through which the penetration device (1) is lowered until it reaches the soil to be penetrated. This pipeline (20) is present in a bore hole, usually prepared using the pipeline (20). Another possibility is that the pipeline (20) is lowered in the seawater until it reaches the sea bottom or a combination. FIG. 2B and FIG. 1B show the device while a tool is penetrating the soil.

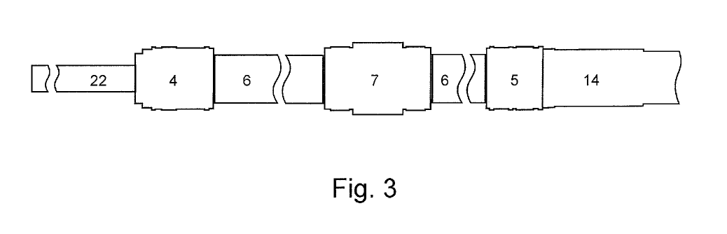

FIG. 3 shows a perspective view of a part of the device in which only the partitioning means (7), the first piston (4), the second piston (5), the housing (14), and a rod (22) that forms an extension from the first piston (4) comprising fixing means (11) for fixedly arranging the tool (2) are shown.

FIG. 4 shows a schematic cross section to illustrate that the partitioning means (7) are fixedly arranged with the tube (3) and the first piston (4) and second piston (5) are slidably displaceable through the cylindrical tube (3). Also shown is a first part of the conduit (28) for transport of hydraulic fluid. This first part of the conduit (28) extends from the first chamber (8) through the piston rod (6). From there it extends through a bore in the second piston (5), towards the pumping means (12) inside the housing (14). A second part of the conduit (28) extends from the pumping means (12) inside the housing (14) back again through another bore in the second piston (5) towards the second chamber (9). The parts of the conduit (28) extending through the bores in the second piston (5) and through the housing (14) are not shown. The fixing means (11) comprise screw thread for fixedly arranging the tool (not shown).

1. A penetration device for driving a tool, such as a soil probing or sampling tool, comprising:
a cylindrical tube,
a first piston and a second piston, both fixedly arranged with a piston rod and slidably displaceable through the cylindrical tube, and
partitioning means for forming a partition between a first chamber and a second chamber,
in which the first piston and the second piston and the tube and the partitioning means together define the first chamber and the second chamber,
wherein the device comprises pumping means for pumping hydraulic fluid from the first chamber to the second chamber or vice versa.

2. The device according to claim 1, wherein the pumping means are located inside the penetration device in the vicinity of the chambers.

3. The device according to claim 2, wherein the cylindrical tube at least partly surrounds the pumping means.

4. The device according to claim 3, wherein the pumping means is slidably displaceable through the cylindrical tube together with the first and second pistons and the piston rod.

5. The device according to claim 1, wherein a conduit is provided which extends from the first chamber to the pumping means and from there to the second chamber.

6. The device according to claim 5, wherein a first part of the conduit extends from the first chamber through the piston rod and through the second piston towards the pumping means, and a second part of the conduit extends from the pumping means through the second piston towards the second chamber.

7. The device according to claim 1, wherein the partitioning means are fixedly arranged with the tube.

8. The device according to claim 1, wherein the partitioning means also form guiding means for guiding the piston rod.

9. The device according to claim 1, wherein it comprises fixing means for fixedly arranging the tool.

10. The device according to claim 1, wherein it comprises reversing means for reversing the pumping direction of the pumping means.

11. The device according to claim 1, wherein it comprises a housing for housing the pumping means.

12. The device according to claim 11, wherein the housing extends in a direction opposite to a direction of penetration approximately starting from the piston that during penetration is the upper piston.

13. The device according to claim 1, wherein it contains driving means for driving the pumping means.

14. The device according to claim 13, wherein it comprises energy storing means coupled to the driving means.

15. The device according to claim 14, wherein the energy storing means comprise a battery pack.

16. The device according to claim 13, wherein it comprises regulatory means for controlling the driving means.

17. The device according to claim 16, wherein it comprises one or more sensors of a group containing a hydraulic fluid pressure sensor, a hydraulic fluid temperature sensor, and a sensor for sensing a conduction of the hydraulic fluid, the sensor being coupled to the regulatory means.

18. The device according to claim 1, wherein it comprises distance measuring means for measuring the distance between a piston and the partitioning means.

19. An assembly of a device according to claim 1 and a tool, the tool being a cone for probing.

20. An assembly of a device according to claim 1 and a tool, the tool being a hollow tube for taking samples.

21. An assembly of a device according to claim 1 and a tool, the tool being a vane tester for determining the shear strength.

22. An assembly of a device according to claim 1 and a tool, the tool being a seismic sensor.
